(19) United States
(12) Patent Application Publication
(10) Pub. No.: US 2013/0342223 A1
(43) Pub. Date: Dec. 26, 2013

(54) FUEL PROPERTY MEASURING DEVICE

(71) Applicant: AISAN KOGYO KABUSHIKI KAISHA, Aichi-ken (JP)

(72) Inventor: Nobuhiro Kato, Aichi-ken (JP)

(21) Appl. No.: 13/916,864

(22) Filed: Jun. 13, 2013

(30) Foreign Application Priority Data
Jun. 21, 2012 (JP) 2012-139622

(51) Int. Cl. G01N 27/22

(52) U.S. Cl. CPC G01N 27/22
USPC 324/663

(57) ABSTRACT

A measuring device for measuring a property of fuel that flows in a fuel chamber, is provided with a substrate including an electrode-placing surface, and a pair of electrodes disposed on the electrode-placing surface with a space between n each other. The substrate is disposed in the fuel chamber so that the electrode-placing surface is inclined with respect to a horizontal direction. The fuel chamber may include an inlet into which the fuel flows, and an outlet out of which the fuel flows. An inlet-side end of the electrode-placing surface may be lower than an outlet-side end of the electrode-placing surface.

### CROSS-REFERENCE TO RELATED APPLICATIONS

This application claims priority to Japanese Patent Application No. 2012-139622 filed on Jun. 21, 2012, the contents of which are hereby incorporated by reference into the present application.

### TECHNICAL FIELD

The technique disclosed in the present description relates to a device for measuring a property of fuel.

### DESCRIPTION OF RELATED ART

Properties and states of fuel can be measured by measuring capacitance of a pair of electrodes immersed in the fuel. For example, in the ease of alcohol blended fuel, an alcohol content can be measured. That is, a relative permittivity of the alcohol blended fuel changes according to the alcohol content and temperature. The alcohol content can be measured by immersing the pair of electrodes in the alcohol blended fuel and measuring the capacitance between the electrodes and the temperature of the alcohol blended fuel.

Japanese Patent Application Publication No. 2011-164085 discloses a measuring device for measuring an alcohol content. In this measuring device, a pair of electrodes includes a large-diameter cylindrical electrode and a small-diameter cylindrical electrode. The large and small-diameter electrodes are arranged coaxially so that the cylindrical portions are stacked. The large and small-diameter electrodes are closed by a gasket at one end of the stacked cylindrical portion, and the large and small-diameter electrodes arc open at the other end. In this measuring device, the pair of electrodes is immersed in alcohol blended fuel, and the capacitance between the large and small-diameter electrodes and the temperature of alcohol blended fuel are measured, whereby the alcohol content is measured.

Those that can be detected from the capacitance between pair of electrodes immersed into fuel are not limited to the alcohol content. In order to measure fuel properties such as gasoline quality or a content of engine oil mixed into fuel, the capacitance between the pair of electrodes immersed in the fuel is also measured.

### SUMMARY

In the measuring device disclosed in Japanese Patent Application Publication No 2011-164085, the pair of electrodes is configured such that the large and small-diameter cylindrical electrodes are stacked and one end thereof is closed. Therefore, When bubbles in the fuel adhere to a space between the pair of electrodes, it is difficult to remove those bubbles. The bubbles adhering to the pair of electrodes can become the cause of capacitance measurement errors.

The present description discloses a technique capable of reducing measurement errors resulting from bubbles adhering to a pair of electrodes.

The present application discloses a measuring device for measuring a property of fuel that flows in a fuel chamber. The measuring device may comprise a substrate including an electrode-placing surface, and a pair of electrodes disposed on the electrode-placing surface with a space between each other. The substrate is disposed in the fuel chamber so that the electrode-placing surface is inclined with respect to a horizontal direction. The fuel chamber may include an inlet into which the fuel flows, and an outlet out of which the fuel flows. An inlet-side end of the electrode-placing surface may be lower than an outlet-side end of the electrode-placing surface.

In the above measuring device, the fuel entering into the fuel chamber through the inlet flows in the fuel chamber and flows out of the fuel chamber through the outlet. The substrate disposed in the fuel chamber has the electrode-placing surface on which a pair of electrodes is arranged and which is inclined with respect to the horizontal direction. Thus, the fuel flowing in the fuel chamber flows from a lower position toward a higher position along the electrode-placing surface of the substrate. On the other hand, when bubbles adhere to the pair of electrodes, upward buoyancy acts on the bubbles. That is, in the above measuring device, the flowing direction of the fuel is identical to the direction of the buoyancy acting on the bubbles. Thus, bubbles are easily removed from the pair of electrodes. Therefore, in the above measuring device, it is possible to reduce measurement errors resulting from the bubbles adhering to the pair of electrodes.

### BRIEF DESCRIPTION OF THE DRAWINGS

FIG. 1 is a cross-sectional view showing a configuration around a fuel tank according to a first embodiment;

FIG. 2 is an enlarged cross-sectional view showing a configuration of a capacitance measuring device according to the first embodiment;

FIG. 3 is an enlarged cross-sectional view showing a configuration of a comb-shaped electrode according to the first embodiment (a view seen from the bottom side of FIG. 2);

FIG. 4 is an enlarged cross-sectional view showing a configuration of a capacitance measuring device according to a second embodiment; and

FIG. 5 is an enlarged cross-sectional view showing a configuration of a capacitance measuring device according to a third embodiment.

### DETAILED DESCRIPTION

First, some of the features of embodiments described below will be described. The features described herein each independently have technical usefulness.

(Feature 1) A substrate is disposed in a fuel chamber so that an electrode-placing surface faces an inner surface of a bottom of a fuel tank. The fuel chamber may include a facing wall that faces the electrode-placing surface. The facing wall may be formed in a set plate which closes an opening formed in the fuel tank. The fuel that is pumped from a fuel pump may flow into the inlet. The fuel that has flowed from the inlet may flow through a space between the electrode-placing surface and the facing wall in the fuel chamber. The fuel that is discharged to the fuel tank from the fuel chamber may flow out from the outlet.

In the above measuring device, the fuel pumped from the fuel pump is supplied into the fuel chamber through the inlet, and the fuel flowing out of the fuel chamber is returned into the fuel tank through the outlet. Since the properties of the fuel pumped from the fuel pump are measured, even if the properties of the fuel are different from position to position in the fuel tank, it is possible to measure the properties of the fuel used in a fuel consuming apparatus with high accuracy.

(Feature 2) An opening of the outlet on a fuel chamber side may be located higher than the pair of electrodes.

Portions of the fuel chamber lower than the opening of the outlet on the fuel chamber side are filled with the fuel that flows into the fuel chamber through the inlet. Thus, the pair of electrodes is always immersed in fuel. Due to this, drying of the pair of electrodes can be prevented.

(Feature 3) At a portion of a fuel path from the inlet to the outlet between the electrode-placing surface and the facing wall, a cross-sectional area of the fuel path on an outlet side may be narrower than a cross-sectional area of the fuel path on an inlet side.

In the above measuring device, the flow rate of the fuel flowing in the fuel chamber increases as it advances from the inlet to the outlet. Thus, the bubbles adhering to the pair of electrodes are easily removed. Due to this, in the above measuring device, it is possible to reduce capacitance measurement errors.

(Feature 4) An inner surface of the facing wall of the fuel chamber may be inclined with respect to the horizontal direction, and the inner surface on the outlet side may be higher than the inner surface on the inlet side.

In the above measuring device, the cross-sectional area of the fuel path on the outlet side is narrower than that on the inlet side. Thus, the flow rate of the fuel flowing in the fuel chamber increases as it advances from the inlet to the outlet. Due to this, the bubbles adhering to the pair of electrodes are easily removed.

(Feature 5) The inlet may be formed in the facing wall of the fuel chamber, and is configured to connect with a fuel supply path that connects the fuel pump and the fuel chamber. The outlet may be formed in the facing wall of the fuel chamber. An outer surface of the facing wall of the fuel chamber may be inclined with respect to the horizontal direction, and the outer surface on an outlet side may be higher than the outer surface on an inlet side.

In the above measuring device, the fuel flowing out from the outlet flows toward the inlet along the outer surface of the facing wall and is returned into the fuel tank through the fuel supply path. Due to this, it is possible to prevent the sound of falling fuel and to improve silence.

(Feature 6) The fuel chamber may comprise an accommodation chamber accommodating the substrate. When an opening of the inlet on an accommodation chamber the side and an opening of the outlet on the accommodation chamber side are connected with a straight line, the straight line may be parallel to the electrode-placing surface.

In the above measuring device, the fuel flowing from the inlet to the outlet through the inside the fuel chamber flows in parallel to the pair of electrodes. Thus, the fuel is likely to flow smoothly at a constant flow rate. Since the bubbles adhering to the pair of electrodes are easily removed, it is possible to reduce capacitance measurement errors.

(Feature 7) The fuel chamber may comprise an accommodation chamber accommodating the substrate, an inlet passage configured to guide the fuel from the inlet to the accommodation chamber, and an outlet passage configured to guide the fuel from the accommodation chamber to the outlet. Wherein the inlet passage, the outlet passage, or both of the inlet passage and the outlet passage may be bent, and a middle portion of the passage which is bent may be located higher than the pair of electrodes

In the above measuring device, bubbles included in the fuel flowing through the inlet passage or the outlet passage are likely to move toward the middle portion (a middle portion of the inlet passage or the outlet passage) located at a higher position than the pair of electrodes due to buoyancy. The bubbles having moved to the middle portion rarely move toward the pair of electrodes located at the lower position than the position of the middle position due to buoyancy. As a result, bubbles are suppressed from adhering to the pair of electrodes, and measurement errors of the measuring device can be reduced.

(Feature 8) In the measuring device disclosed in the present description, a degassing port may be formed in the fuel chamber.

In the above measuring device, since bubbles in the fuel chamber are discharged from the degassing port, bubbles are suppressed from adhering to the pair of electrodes. Thus, it is possible to reduce measurement errors of the measuring device.

(Feature 9) The measuring device may further comprise a signal processing circuit connected to the pair of electrodes, and configured to processes signals that are output from the pair of electrodes. The signal processing circuit, the substrate, and the pair of electrodes may be configured integrally. The signal processing circuit, the substrate, and the pair of electrodes that are configured integrally may be detachably attached to the facing wall formed in the set plate.

In the above measuring device, the signal processing circuit, the substrate, and the pair of electrodes are configured integrally, and are separated from the set plate on which the facing wall of the fuel chamber is formed. Thus, it is possible to easily replace a sensor unit that includes the signal processing circuit, the substrate, and the pair of electrodes.

(Feature 10) In the measuring device disclosed in the present description, each electrode that configures the pair of electrodes may be formed in a comb-shape.

In the above measuring device, since the pair of electrodes has a comb-shape, the facing area of the electrodes is large as compared to the physical size of the electrode. Thus, it is possible to decrease the size of the pair of electrodes.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved fuel property measuring devices, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### First Embodiment

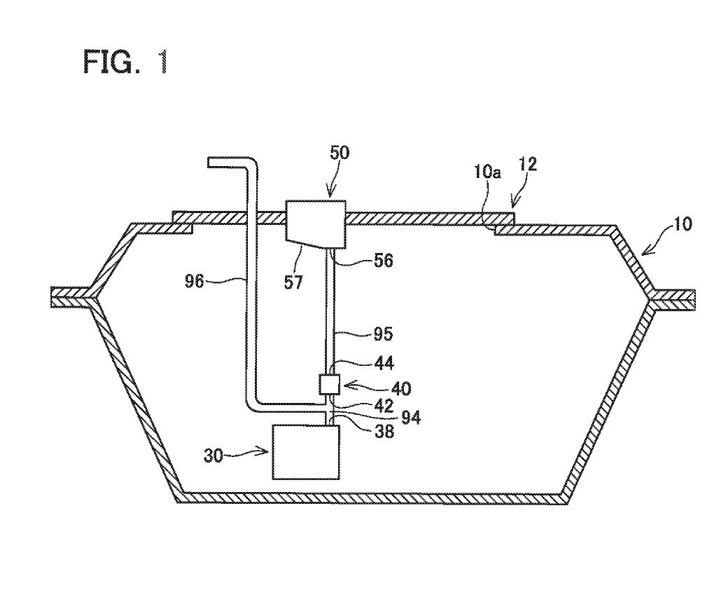

FIG. 1 shows a configuration around a fuel tank 10 according to the first embodiment. A fuel pump 30 is accommodated in the fuel tank 10. The fuel pump 30 sucks fuel in the fuel tank 10 from a suction port (not shown) and pumps out the sucked fuel from a discharge port 38. A pipe 94 is connected to the discharge port 38, and an inlet 42 of a pressure regulator 40 is connected to the pipe 94. The pressure regulator 40 has a valve which allows the inlet 42 to communicate with an outlet 44 when the pressure of the fuel acting on the inlet 42 becomes a predetermined value or more. When the pressure of the inlet 42 becomes the predetermined value or smaller, the valve is closed so that the inlet 42 and the outlet 44 do not communicate with each other. The pressure regulator 40 regulates the pressure of the fuel in the pipe 94 to be constant by discharging surplus fuel from the outlet 44. A pipe 96 branches off from the pipe 94, and the pipe 96 is connected to an injector via a delivery pipe. The fuel in the fuel tank 10 is pumped to the injector with the pressure adjusted to be constant by the fuel pump 30 and the pressure regulator 40. The fuel pump 30 is driven so that the pressure of the fuel pumped from the fuel pump 30 is higher than the predetermined pressure at which the pressure regulator 40 operates. Thus, when the fuel pump 30 is driven, the pressure regulator 40 is always opened, and surplus fuel is delivered from the pressure regulator 40.

One end of the pipe 95 is connected to the outlet 44 of the pressure regulator 40, and the other end of the pipe 95 is connected to the inlet 56 of the capacitance measuring device 50. The fuel delivered from the outlet 44 of the pressure regulator 40 is delivered to the capacitance measuring device 50, in which the capacitance is measured, and is then returned from the outlet 57 to the fuel tank 10.

The fuel pump 30, the pressure regulator 40, the capacitance measuring device 50, the pipes 94, 95, and 96, and the like are fixed to a set plate 12. The set plate 12 is fixed to the fuel tank 10 to close an opening 10a of the fuel tank 10 and aligns the fuel pump 30, the pressure regulator 40, the capacitance measuring device 50, the pipes 94, 95, and 96, and the like within the fuel tank 10.

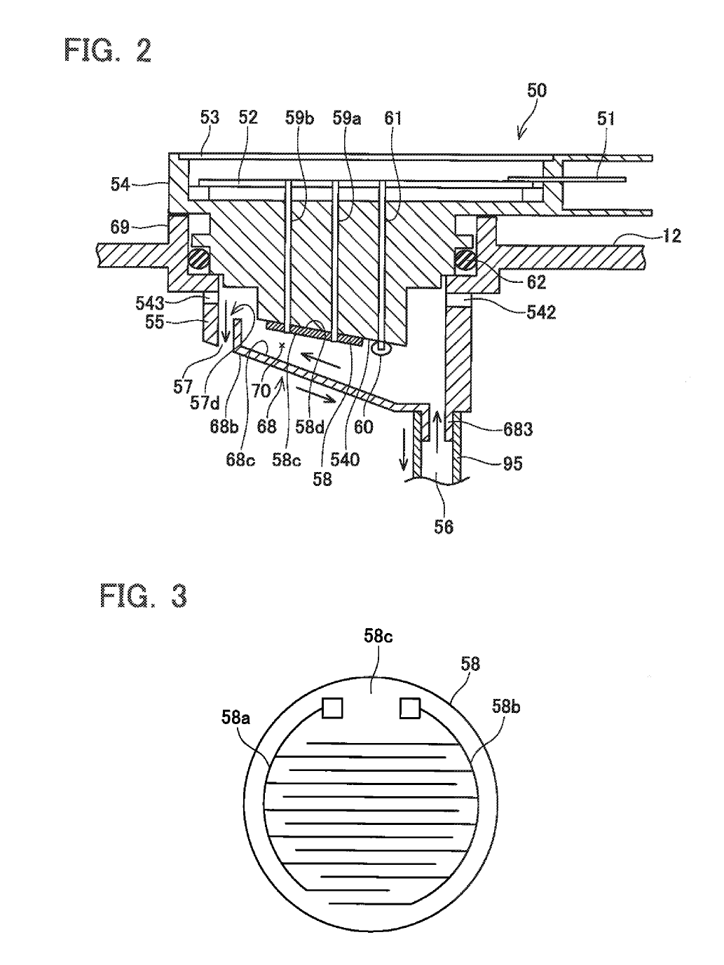

FIG. 2 shows the structure of the capacitance measuring device 50. A cylindrical wall 55 that extends downward from the set plate 12 is formed on the set plate 12, and the lower end of the cylinder 55 is closed by a bottom wall 68. The inlet 56 is formed on one end (the right side in FIG. 1) of the bottom wall 68, and the outlet 57 is formed on the left side. A cylindrical portion 683 that protrudes downward from the bottom wall 68 is formed in the inlet 56. The upper end of the pipe 95 is attached to the cylindrical portion 683. The outlet 57 is a penetration hole that penetrates through the bottom wall 68. The lower surface of the bottom wall 68 at the position where the outlet 57 is formed is flat.

A cylindrical wall 69 that extends upward from the set plate 12 is further formed on the set plate 12. When the set plate 12 is viewed in a plan view, the cylindrical wall 55 is positioned on the inner side of the cylindrical wall 69. A sensor body 54 is inserted into the inner side of the cylindrical wall 69. A space between the cylindrical wall 69 and the sensor body 54 is hermetically maintained by an O-ring 62. A space surrounded by the cylinder 55, the sensor body 54, and the bottom wall 68 is a fuel chamber 70.

A sensor board 58 is attached to a lower surface 540 of the sensor body 54. An upper surface 58d of the sensor board 58 is fixed to the lower surface 540 of the sensor body 54. As shown in FIG. 3, a pair of electrodes 58a and 58b is formed on a lower surface 58c of the sensor board 58. The electrodes 58a and 58b are comb-shaped electrodes, and the comb-shaped portions of the electrodes 58a and 58b face each other. Since the electrodes 58a and 58b are configured as comb-shaped electrodes, the facing areas of the electrodes 58a and 58b are large as compared to their physical sizes, and the capacitance between the electrodes 58a and 58b is large. Thus, the area of the lower surface 58c of the sensor board 58 can be decreased. In this way, it is possible to decrease the probability of bubbles to adhere to the electrodes 58a and 58b and to reduce measurement errors resulting from bubbles.

A circuit board 52 is attached to an upper portion of the sensor body 54. An upper side of the circuit board 52 is closed by a lid 53. The circuit board 52 is accommodated in a space surrounded by the sensor body 54 and the lid 53. Wires 59a and 59b are connected to the circuit board 52. The wires 59a and 59b extend downward while passing through the sensor body 54. The lower end of the wire 59a is connected to the electrode 58a, and the lower end of the wire 59b is connected to the electrode 58b. A thermistor 60 for measuring temperature is disposed on the lower surface 540 of the sensor body 54. Wires 61a and 61b (collectively denoted by number 61 in FIG. 2) connected to the thermistor 60 extend upward while passing through the sensor body 54 and are connected to the circuit board 52.

The lower surface 540 of the sensor body 54 is inclined with respect to a horizontal direction. Specifically, the lower surface 540 is inclined such that the height increases as it advances from the inlet 56 to the outlet 57. Thus, the upper surface 58d and the lower surface 58c (a surface on which the pair of electrodes 58a and 58b is disposed) of the sensor board 58 attached to the lower surface 540 are also inclined such that the height increases as it advances from the inlet 56 to the outlet 57.

An inner surface 68c of the bottom wall 68 is also inclined similarly to the lower surface 540 such that the height increases as it advances from the inlet 56 to the outlet 57. However, the inclination of the inner surface 68c of the bottom wall 68 is steeper than the inclination of the lower surface 540. Thus, the width of a fuel path in a portion interposed between the lower surface 540 and the inner surface 68c of the bottom wall 68 decreases as it advances from the inlet 56 to the outlet 57. Therefore, the flow rate of the fuel flowed in through the inlet 56 increases as the fuel moves from the inlet 56 toward the outlet 57. Since the flow rate of the fuel increases, the bubbles adhering to the pair of electrodes 58a and 58b are easily removed.

The outlet 57 has an opening 57d on the fuel chamber side. The opening 57d is disposed at a position higher than the pair of electrodes 58a and 58b. When fuel flows into the fuel chamber 70 through the inlet 56, portions of the fuel chamber 70 lower than the opening 57d are filled with fuel. Thus, the pair of electrodes 58a and 58b is always immersed in the fuel. Due to this, drying of the pair of electrodes 58a and 58b can be prevented. As a result, it is possible to prevent foreign matters from adhering to the pair of electrodes 58a and 58b.

Exhaust ports 542 and 543 are formed in portions of the cylindrical wall 55 closer to the inlet 56 and the outlet 57, respectively. The exhaust ports 542 and 543 are penetration holes formed in the cylindrical wall 55 and allow the inner space of the wall 55 to communicate with the inner space of the fuel tank 10. The exhaust ports 542 and 543 are formed in the midway of the fuel paths that extend from the inlet 56 and the outlet 57, respectively, and reach the pair of electrodes 58a and 58b. Specifically, the exhaust ports 542 and 543 are formed in bent portions (at the highest positions) of these fuel paths. Some of the bubbles entering into the fuel chamber 70 are exhausted outside the fuel chamber 70 through the exhaust ports 542 and 543. In this manner, it is possible to suppress bubbles from adhering to the pair of electrodes 58a and 58b.

The circuit board 52 specifies an alcohol content in the fuel from a signal output from the pair of electrodes 58a and 58b and a signal output from the thermistor 60. The circuit board 52 can be configured, for example, using a circuit that applies an AC voltage to the pair of electrodes 58a and 58b, a circuit that specifies the capacitance between the pair of electrodes 58a and 58b from the signal output from the pair of electrodes 58a and 58b, a circuit that specifies a fuel temperature from a resistance value of the thermistor 60, and a circuit that outputs a value proportional to the alcohol content in the fuel from the specified capacitance and fuel temperature. The circuit board 52 includes a terminal pin 51. The alcohol content in the fuel specified by the circuit board 52 is output from the terminal pin 51.

In the capacitance measuring device 50 of the present embodiment, a portion (so-called surplus fuel) of the fuel pumped out from the fuel pump 30 is supplied from the pressure regulator 40 to the capacitance measuring device 50 through the pipe 95. The fuel supplied to the capacitance measuring device 50 flows into the fuel chamber 70 through the inlet 56. The fuel having flown into the fuel chamber 70 flows from a lower position to a higher position along the inclination of the lower surface 58c (the pair of electrodes 58a and 58b) of the sensor board 58, and then is returned into the fuel tank 10 from the outlet 57. When bubbles are included in the fuel flowed into the fuel chamber 70, an upwardly-oriented buoyancy acts on the bubbles, and the orientation of the buoyancy is identical to the direction of the fuel flowing in the fuel chamber 70. Thus, even if the bubbles in the fuel flowed into the fuel chamber 70 adhere to the pair of electrodes 58a and 58b, the bubbles are easily removed from the electrodes 58a and 58b. Therefore, in the capacitance measuring device 50 of the present embodiment, capacitance measurement errors can be decreased.

The fuel discharged from the outlet 57 flows toward the inlet 56 along the lower surface 68b of the bottom wall 68 and is returned into the fuel tank 10 through the pipe 95. That is, the lower surface (the outer surface of the fuel chamber 70) of the bottom wall 68 is inclined such that the height decreases as it advances from the outlet 57 (the left side of FIG. 2) to the inlet 56 (the right side of FIG. 2). Thus, the fuel flowing out from the outlet 57 flows from the outlet 57 toward the inlet 56 along the lower surface 68d of the bottom wall 68. Moreover, the fuel flows downward through the pipe 95 and returns to the fuel in the fuel tank 10. Due to this, it is possible to prevent the sound of falling fuel and to improve silence as compared to when fuel falls directly from the outlet 57 into the fuel tank 10.

Further, in the capacitance measuring device 50 of the present embodiment, the sensor body 54 and the set plate 12 are separate components and both are configured to be detached from each other. Thus, the circuit board 52, the sensor board 58, the pair of electrodes 58a and 58b, the thermistor 60, the bottom wall 68 of the fuel chamber 70, and the cylinder 55 can be detached from each other. Thus, by replacing the sensor body 54, the circuit board 52, the sensor board 58, the pair of electrodes 58a and 58b, and the thermistor 60 can be easily replaced.

Finally, the correspondence between the first embodiment and the claims will be described. The lower surface 58c of the sensor board 58 is an example of an “electrode-placing surface” described in the claims, the bottom wall 68 is an example of a “facing wall” described in the claims, the pipe 95 is an example of a “fuel supply path”, the exhaust ports 542 and 543 are each an example of a “degassing port”, and the circuit board 52 is an example of a “signal processing circuit”.

### Second Embodiment

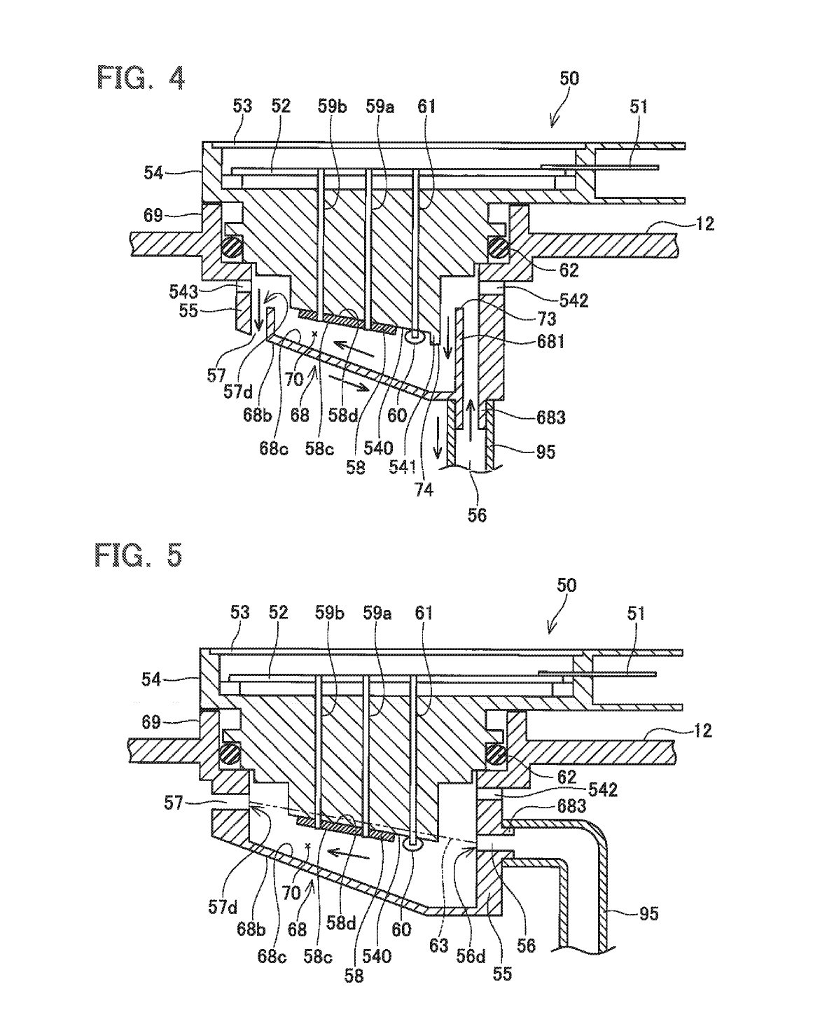

A second embodiment of a capacitance measuring device 50 will be described with reference to FIG. 4. In the following description, members that are the same as or similar to the members described above will be denoted by the same numbers, and redundant description thereof will not be provided. In the capacitance measuring device 50 of the present embodiment, an interruption plate 681 that protrudes upward is formed on an end of a bottom wall 68 closer to an inlet 56. An upper end 73 of the interruption plate 681 is at a higher position than a pair of electrodes 58a and 58b. An interruption plate 541 that protrudes downward is formed on an end of a lower surface 540 closer to the inlet 56. A lower end 74 of the interruption plate 541 is at a lower position than the pair of electrodes 58a and 58b. A fuel path that extends from the inlet 56 to reach the pair of electrodes 58a and 58b is formed in a fuel chamber 70. A fuel path extends from the inlet 56 located at a lower position than the pair of electrodes 58a and 58b to reach the pair of electrodes 58a and 58b through the upper end of the interruption plate 681 located at a higher position than the pair of electrodes 58a and 58b and the lower end of the interruption plate 541 located at a lower position than the pair of electrodes 58a and 58b. In other words, a bent fuel path is formed between the inlet 56 and the pair of electrodes 58a and 58b.

Bubbles included in fuel flowed in through the inlet 56 move from the inlet 56 to the upper end 73 of the interruption plate 681 by buoyancy thereof. The pair of electrodes 58a and 58b is under the upper end 73 of the interruption plate 681. Further, the interruption plate 541 is disposed between the interruption plate 681 and the pair of electrodes 58a and 58b. The lower end 74 of the interruption plate 541 is located further under the pair of electrodes 58a and 58b as viewed from the upper end of the interruption plate 681. Thus, bubbles that have moved to the upper end 73 of the interruption plate 681 rarely reach the pair of electrodes 58a and 58b. As a result, bubbles are suppressed from adhering to the pair of electrodes 58a and 58b, and measurement errors of the capacitance measuring device 50 can be reduced.

In the above embodiment, a case where the interruption plates 681 and 541 are formed on a side of the fuel chamber 70 closer to the inlet 56 has been described. However, the interruption plates 681 and 541 may be formed on a side of the fuel chamber 70 closer to the outlet 57, and in this case, the same advantages can be obtained.

The correspondence between the second embodiment and the claims will be described. In FIG. 4, a space formed between the sensor body 54 and the bottom wall 68 is an example of an “accommodation chamber”, the fuel path that extends from the inlet 56 in the fuel chamber 70 and reaches the pair of electrodes 58a and 58b is an example of an “inlet passage”, a fuel path that extends from the pair of electrodes 58a and 58b in the fuel chamber 70 and reaches the outlet 57 is an example of an “outlet passage”, and a space above the interruption plate 681 is an example of a “middle portion”.

### Third Embodiment

A third embodiment of a capacitance measuring device 50 will be described. In the present embodiment, an inlet 56 and an outlet 57 are formed on a side surface of a cylindrical wall 55. In FIG. 5, a straight line 63 connects an opening 56d of the inlet 56 on the e side of a fuel chamber 70 and an opening 57d of the outlet 57 on the inner side of the fuel chamber 70. The inlet 56 and the outlet 57 are disposed so that the straight line 63 and a lower surface 58c of a sensor board 58 are parallel to each other. Thus, fuel is likely to flow smoothly at a constant flow rate. Thus, when bubbles adhere to a pair of electrodes 58a and 58b, bubbles are easily removed. Due to this, measurement errors can be reduced.

In the above description, the fuel delivered through an outlet 44 of a pressure regulator 40 flows into the inlet 56 of the fuel chamber 70. However, in some cases, a return pipe that collects fuel into a fuel tank 10 from an injector may be formed in the fuel tank 10. In this case, the fuel collected from the injector may flow into the fuel chamber 70. That is, an end of the return pipe closer to the fuel tank 10 may be connected to the inlet 56 of the fuel chamber 70. Further, in some cases, a vapor jet pipe that discharges fuel vapor generated by the negative pressure in a fuel pump 30 to the outside of the pipe together with fuel around the vapor may be formed in the fuel pump 30. In this case, fuel from the vapor jet pipe may flow into the fuel chamber 70. That is, an end of the vapor jet pipe may be connected to the inlet 56 of the fuel chamber 70.

In the above description, a case where all of a lower surface 540 of at sensor body 54, an upper surface 58d of the sensor board 58, and the lower surface 58c of the sensor board 58 are inclined such that the height increases as it advances from the inlet 56 to the outlet 57 has been described. However, only the lower surface 58c of the sensor board 58 may be inclined such that the height increases as it advances from the inlet 56 to the outlet 57, and the lower surface 540 of the sensor body 54 and the upper surface 58d of the sensor board 58 may not be inclined in such a manner. For example, the lower surface 540 of the sensor body 54 and the upper surface 58d of the sensor hoard 58 may be horizontally parallel.

In the above description, a case where an inner surface 68c and an outer surface 68b of a bottom wall 68 are parallel to each other has been described. However, the inner surface 68c and the outer surface 68c are not necessarily parallel to each other.

What is claimed is:

1. A measuring device for measuring a property of fuel that flows in a fuel chamber, the measuring device comprising:
a substrate including an electrode-placing surface; and
a pair of electrodes disposed on the electrode-placing surface with a space between each other; wherein
the substrate is disposed in the fuel chamber so that the electrode-placing surface is inclined with respect to a horizontal direction,
the fuel chamber includes an inlet into which the fuel flows, and an outlet out of which the fuel flows, and
an inlet-side end of the electrode-placing surface is lower than an outlet-side end of the electrode-placing surface.

2. The measuring device according to claim 1, wherein
the substrate is disposed in the fuel chamber so that the electrode-placing surface faces an inner surface of a bottom of a fuel tank,
the fuel chamber includes a facing wall that faces the electrode-placing surface,
the facing wall is formed in a set plate which closes an opening formed in the fuel tank,
the fuel that is pumped from a fuel pump flows into the inlet,
the fuel that has flowed from the inlet flows through a space between the electrode-placing surface and the facing wall in the fuel chamber, and
the fuel that is discharged to the fuel tank from the fuel chamber flows out from the outlet.

3. The measuring device according to claim 2, wherein
an opening of the outlet on a fuel chamber side is located higher than the pair of electrodes.

4. The measuring device according to claim 3, wherein
at a portion of a fuel path from the inlet to the outlet between the electrode-placing surface and the facing wall, a cross-sectional area of the fuel path on an outlet side is narrower than a cross-sectional area of the fuel path on an inlet side.

5. The measuring device according to claim 4, wherein
an inner surface of the facing wall of the fuel chamber is inclined with respect to the horizontal direction, and
the inner surface on the outlet side is higher than the inner surface on inlet side.

6. The measuring device according to claim 5, wherein
the inlet is formed in the facing wall of the fuel chamber, and is configured to connect with a fuel supply path that connects the fuel pump and the fuel chamber,
the outlet is formed in the facing wall of the fuel chamber, and
an outer surface of the facing wall of the fuel chamber is inclined with respect to the horizontal direction, and the outer surface on an outlet side is higher than the outer surface on an inlet side.

7. The measuring device according to claim 6, wherein
the fuel chamber comprises an accommodation chamber accommodating the substrate, and
when an opening of the inlet on an accommodation chamber side and an opening of the outlet on the accommodation chamber side are connected with a straight line, the straight line is parallel to the electrode-placing surface.

8. The measuring device according to claim 7, wherein
each electrode configuring the pair of electrodes is formed in a comb-shape.

9. The measuring device according to claim 1, wherein
the fuel chamber comprises:
an accommodation chamber accommodating the substrate;
an inlet passage configured to guide the fuel from the inlet to the accommodation chamber; and
an outlet passage configured to guide the fuel from the accommodation chamber to the outlet, wherein
the inlet passage, the outlet passage, or both of the inlet passage and the outlet passage are bent, and a middle portion of the passage which is bent is located higher than the pair of electrodes

10. The measuring device according to claim 1, wherein
a degassing port is formed in the fuel chamber.

11. The measuring device according to claim 2, further comprising:
a signal processing circuit connected to the pair of electrodes, and configured to processes signals that are output from the pair of electrodes, wherein
the signal processing circuit, the substrate, and the pair of electrodes are configured integrally; and
the signal processing circuit, the substrate, and the pair of electrodes that are configured integrally are detachably attached to the facing wall formed in the set plate.

12. The measuring device according to claim 1, wherein
each electrode configuring the pair of electrodes is formed in a comb-shape.

13. The measuring device according to claim 5, wherein
the inlet is formed in the facing wall of the fuel chamber, and is configured to connect with a fuel supply path that connects the fuel pump and the furl chamber,
the outlet is formed in the facing wall of the fuel chamber, and
an outer surface of the facing wall of the fuel chamber is inclined with respect to the horizontal direction, and the outer surface on an outlet side is higher than the outer surface on an inlet side.

14. The measuring device according to claim 8, wherein
a degassing port is formed in the fuel chamber.

15. The measuring device according to claim 2, wherein
at a portion of a fuel path from the inlet to the outlet between the electrode-placing surface and the facing wall, a cross-sectional area of the fuel path on an outlet side is narrower than a cross-sectional area of the fuel path on an inlet side.

16. The measuring device according to claim 2, wherein
the inlet is formed in the facing wall of the fuel chamber, and is configured to connect with a fuel supply path that connects the fuel pump and the fuel chamber,
the outlet is formed in the facing wall of the fuel chamber, and
an outer surface of the facing wall of the fuel chamber is inclined with respect to the horizontal direction, and the outer surface on an outlet side is higher than the outer surface on an inlet side.

17. An apparatus comprising:
a fuel chamber in which fuel flows, the fuel chamber including a fuel inlet and a fuel outlet;
a substrate disposed within the fuel chamber, the substrate including an electrode placing surface which is inclined with respect to a horizontal direction, wherein an inlet-side end of the electrode-placing surface is lower than an outlet-side end of the electrode-placing surface; and
a pair of electrodes disposed on the electrode-placing surface with a space between each other.

18. The apparatus according to claim 17, further comprising:
a signal processing circuit connected to the pair of electrodes, and configured to processes signals that are output from the pair of electrodes.
